(19) United States
(12) Patent Application Publication
(10) Pub. No.: US 2016/0046094 A1
(43) Pub. Date: Feb. 18, 2016

(54) HYBRID WOOD PRODUCTS

(71) Applicant: ARMSTRONG WORLD INDUSTRIES, INC., Lancaster, PA (US)

(72) Inventors: BRIAN BEAKLER, York, PA (US); STEVEN BUKOWSKI, East Petersburg, PA (US); SUNIL RAMACHANDRA, Lancaster, PA (US)

(73) Assignee: ARMSTRONG WORLD INDUSTRIES, INC., Lancaster, PA (US)

(21) Appl. No.: 14/780,146

(22) PCT Filed: Mar. 28, 2014
(86) PCT No.: PCT/US2014/032174

§ 371 Date: Sep. 25, 2015

Related U.S. Application Data
(60) Provisional application No. 61/806,702, filed on Mar. 29, 2013.
(60) Provisional application No. 61/806,702, filed on Mar. 29, 2013.

(51) Int. Cl. B32B 3/06; B32B 7/12; B32B 21/10; B32B 21/02

(52) U.S. Cl. CPC B32B 3/06; B32B 21/02; B32B 7/12; B32B 21/10; B32B 2307/72; B32B 2307/51; B32B 2471/00; B32B 2262/062

(57) ABSTRACT

Described herein are hybrid wood products comprising: a first layer comprising a first thermally compressed cellulosic substrate; a second layer comprising a fiberboard, a wood-plastic composite, or a vinyl composite; and a locking profile.

### CROSS-REFERENCE TO RELATED PATENT APPLICATION

This application claims the benefit of priority to U.S. Provisional Application Ser. No. 61/806,702, filed Mar. 29, 2013, the contents of which are hereby incorporated herein in their entirety.

### FIELD OF THE DISCLOSURE

The present invention is directed to a treated cellulosic material. More specifically, the present invention is directed to flooring having a densified cellulosic substrate.

### BACKGROUND

Wood flooring endures seasonal expansion and contraction when exposed to variations in equilibrium moisture content (EMC). When EMC levels plummet, boards shrink, creating spaces between the wood flooring boards. During periods of both elevated EMC and depressed EMC, installed wood flooring boards change dimension creating cupping (moisture adsorption from the bottom of the product), a condition in which the edges of the board are high and the center is low; or crowning (moisture adsorption from the top or face of the product), the opposite of cupping, where the middle of the board is higher than the edges of the board. The tendency of wood flooring to exhibit cupping or crowning in humid conditions and dry conditions is a limitation for use of wood flooring in below grade installations and low EMC installations and further exacerbated when wider width wood flooring, for example, when products greater than 3.25 inches wide, are installed.

Engineered wood flooring is a multiple-layered structure having a top layer of decorative wood veneer bonded to multiple core or base layers of a manufactured wood product, for example, fiberboard and veneer core plywood. Engineered wood floors have a greater resistance to dimensional change in elevated EMC conditions than solid wood flooring and appeal to use in below grade and in regions of high EMC. In the case of dry EMC conditions however, dimensional changes in engineered wood flooring lead to in-service issues. Engineered wood flooring made with rotary-peeled face veneers tends to exhibit veneer checking or lathe checks, a condition that creates micro cracks in the decorative wood veneer layer of the product.

Flooring materials are subjected to impacts from objects that may be inadvertently dropped onto surfaces, potentially creating a permanent depression or dent in the flooring surface. Indent resistance of wood flooring products is influenced by the specific gravity of the wood-type used to make the flooring product. Additionally, indent resistance is increased beyond that of the wood-type of the face veneer by use of chemical impregnation. However, in addition to the added cost, traditional impregnation chemicals may impinge on potential environmentally friendly (green) positioning of wood flooring products.

In the normal service of wood flooring products, especially solid wood and wood veneers, fading or change in color occurs when wood flooring products are exposed to ultraviolet light, such as sunlight through a window. Remediation steps to restore the initial color of the wood flooring include sanding, stripping, and refinishing or board replacement.

A wood flooring product that is dimensionally stable to variations in EMC, resists veneer checks, indent resistant, and resists fading from exposure to sunlight would be desirable in the art.

### SUMMARY

Some embodiments of the present invention provide a hybrid wood product, comprising: a first layer comprising a first thermally compressed cellulosic substrate; a second layer comprising a fiberboard, a wood-plastic composite, or a vinyl composite; and a locking profile.

Other embodiments provide a densified wood product having a first layer and a second layer wherein the first layer is a densified wood veneer and the second layer is bonded to the first layer.

Further embodiments provide a densified wood product where the first layer is a densified wood, the second layer is bonded to the first layer, and the product is machined to include a locking profile, e.g. tongue and groove edges.

Other features and advantages of the present invention will be apparent from the following more detailed description of the preferred embodiment.

### DETAILED DESCRIPTION

As used herein, the terms “thermally compressed” or “thermal compression” refer to products or processes that use—inter alia—heat and mechanical compression to densify a substrate. Exemplary thermal compression techniques are described in U.S. Pat. No. 7,404,422 to Kamke et al., the contents of which are hereby incorporated herein in their entirety.

In some embodiments, the compression process comprises the following steps: providing an apparatus comprising: a top calendar roll; a bottom calendar roll; a heat source; and an in-feed conveyor; wherein the distance between the top calendar roll and the bottom calendar roll defines a separation gap; providing a cellulosic substrate having a thickness greater than the separation gap; and feeding the cellulosic substrate through the separation gap between the top calendar roll and the bottom calendar roll.

Some embodiments of the present invention provide a hybrid wood product, comprising: a first layer comprising a first thermally compressed cellulosic substrate; a second layer comprising a fiberboard, a wood-plastic composite, or a vinyl composite; and a locking profile.

In some embodiments, the first thermally compressed cellulosic substrate comprises a cellulosic material derived from a soft wood or a tropical wood. In some embodiments, the first thermally compressed cellulosic substrate comprises a cellulosic material derived from Caribbean walnut, coffee bean, natural bamboo, Australian cypress, white oak, Tasmanian oak, ribbon gum, ash, American beech, red oak, Caribbean heart pine, yellow birch, Movingui, heart pine, Carapa Guianensis, larch, carbonized bamboo, teak, cocobolo, rose gum, Makore, Siberian larch, Peruvian walnut, Boreal, black walnut, cherry, red maple, boire, paper birch, eastern red cedar, southern yellow pine, lacewood, African mahogany, Honduran mahogany, Parana, sycamore, Shedua, silver maple, Douglas fir, juniper, chestnut, hemlock, western white pine, basswood, eastern white pine, balsa, cuipo or a combination of two or more thereof.

In some embodiments, the first thermally compressed cellulosic substrate comprises a cellulosic material derived from eastern white pine, hemlock, catalpa, alder, cypress, Douglas fir, hackberry, cherry or a combination thereof.

In some embodiments, the second layer comprises a fiberboard. In some embodiments, the fiberboard comprises a matrix of cellulosic fibers.

In some embodiments, the fiberboard further comprises a binder. In some embodiments, the binder comprises a formaldehyde based resin, isocyanate, polyvinyl alcohol, soy, or a combination of two or more thereof. In some embodiments, the formaldehyde based resin is selected from urea formaldehyde; phenol formaldehyde; and a combination thereof.

In some embodiments, the fiberboard has a moisture content of less than 9%. In some embodiments, the fiberboard has a moisture content of less than 8%. In some embodiments, the fiberboard has a moisture content of less than 7%. In some embodiments, the fiberboard has a moisture content of less than 6%. In some embodiments, the fiberboard has a moisture content of less than 5%.

In some embodiments, the fiberboard has a density of from about 10 lbs./ft³ to about 75 lbs./ft³. In some embodiments, the fiberboard has a density of from about 15 lbs./ft³ to about 70 lbs./ft³. In some embodiments, the fiberboard has a density of from about 20 lbs./ft³ to about 65 lbs./ft³. In some embodiments, the fiberboard has a density of from about 25 lbs./ft³ to about 50 lbs./ft³.

In some embodiments, the fiberboard has a thickness of from about 3 mm to about 14 mm. In some embodiments, the fiberboard has a thickness of from about 4 mm to about 12 mm. In some embodiments, the fiberboard has a thickness of from about 5 mm to about 10 mm.

In some embodiments, the second layer has a modulus of elasticity of from about 30,000 psi to about 1,000,000 psi. Some embodiments provide a second layer having a modulus of elasticity of from about 40,000 psi to about 900,000 psi. Other embodiments provide a second layer having a modulus of elasticity of from about 50,000 psi to about 500,000 psi.

In some embodiments, the second layer is bonded to the first layer using an adhesive.

In some embodiments, the hybrid product comprises a locking profile is selected from tongue and groove; lock and fold; ship-lap; angle-angle; and click-lock. In other embodiments, the locking profile is selected from tongue and groove and lock and fold. Suitable locking profiles are described, for example, in U.S. Pat. No. 8,544,234 to Pervan et al. or U.S. Pat. No. 6,874,292 to Moriau et al., the contents of which are hereby incorporated herein in their entireties. In some embodiments, the second layer comprises the locking profile.

In some embodiments, the adhesive comprises a pressure sensitive adhesive. In some embodiments, the adhesive comprises a heat sensitive adhesive, e.g. ethylene vinyl acetate.

In some embodiments, the hybrid product has a thickness of from about 6 mm to about 12 mm. In some embodiments, the hybrid product has a width of from about 75 mm to about 200 mm.

Some embodiments provide a product comprising a third layer. In some embodiments, the third layer comprises a second thermally compressed cellulosic substrate.

In some embodiments, the second thermally compressed cellulosic substrate comprises a cellulosic material derived from a soft wood or a tropical wood. In some embodiments, the second thermally compressed cellulosic substrate comprises a cellulosic material derived from Caribbean walnut, coffee bean, natural bamboo, Australian cypress, white oak, Tasmanian oak, ribbon gum, ash, American beech, red oak, Caribbean heart pine, yellow birch, Movingui, heart pine, Carapa Guianensis, larch, carbonized bamboo, teak, cocobolo, rose gum, Makore, Siberian larch, Peruvian walnut, Boreal, black walnut, cherry, red maple, boire, paper birch, Eastern red cedar, southern yellow pine, lacewood, African mahogany, Honduran mahogany, Parana, sycamore, Shedua, silver maple, Douglas fir, juniper, chestnut, hemlock, western white pine, basswood, eastern white pine, balsa, cuipo and a combination of two or more thereof.

In some embodiments, the first thermally compressed cellulosic substrate and the second thermally compressed cellulosic substrate are comprised of the same material.

Some embodiments of the present disclosure permit the manufacture of densified wood products and materials that are indent resistant, dimensionally stable from variations in equilibrium moisture content, and resistant to fading. Some embodiments are further processed by cutting and shaping to include flooring and underlayment materials, trim, and furniture manufacture.

According to the American National Standards Institute, a veneer is a thin sheet of wood, rotary cut, sliced, or sawed from a log, bolt, or flitch. The formation of densified wood and densified veneer products would permit the manufacture of, for example, wood flooring having densified wood or veneer in the core construction or as decorative layer.

A commonly occurring and costly problem in wood manufacturing is the development of small cracks or micro cracks in the wood finish called lathe checks or veneer checks. Veneer checks usually appear as uniformly spaced hairline cracks in the finish, or in severe cases, cracks with accompanying ridges on the wood surface which actually can be detected by touch. Veneer checks are typically formed when tensile stress failures occur in the face veneer, caused by differential shrinkage or swelling between the face veneer and the panel substrate to which it is applied. As the EMC of the environment changes, so does the moisture content of the wood panel. Changes in moisture content of the wood panel affect shrinkage and swelling of the wood panel. When a veneered panel shrinks or swells, the veneer may not expand or contract at the same rate as the substrate due to the material orientation or construction. This can create considerable stresses within the panel which, if great enough, result in wood failure. Such failures in the face veneer then create tensile stress concentrations in the finish which result in the visible cracks or veneer checks. In one embodiment, veneer checks formed from the veneer process were compressed and closed after densifying the wood veneer, and, therefore, engineered wood flooring made with densified rotary-peeled face veneers are suitable for installations having dry environmental conditions.

In one embodiment, the wood flooring product includes multiple layers. Although two layers are detailed herein, the wood flooring product includes about three layers, about four layers, about five layers, about six layers, about seven layers, about eight layers, about nine layers, about ten layers, about eleven layers, or additional layers as warranted by the product construction. In one embodiment, a densified wood or veneer is positioned as a top or decorative layer in a multi-layer wood flooring product. In another embodiment, the densified wood or veneer forms the base of a layered wood flooring product. In yet another embodiment, the densified wood is positioned throughout a layered wood flooring product to improve the dimensional stability of the layered wood flooring product.

In one embodiment, the top layer, also referred to as a first layer or decorative layer, includes a densified veneer. The top layer is bonded to one or more layers by epoxy, urethane, acrylate, acetate, phenol formaldehyde, urea formaldehyde, isocyanate, soy, starch, or protein-based, or other biobased adhesives, or any other bonding agent as known in the arts. In one embodiment, the base layer is solid wood such as a hard wood, a soft wood, or a porous material such as cork.

In one embodiment, the densified top layer is bonded to one or more layers where the base layer is a manufactured cellulosic product, for example medium density fiberboard, high density fiberboard, plywood, oriented strand board, chipboard, felt, or any other suitable product. In one embodiment, the densified top layer is bonded to one or more layers where the base layer is cement, concrete, or composites thereof In yet another embodiment, the base layer contains a polymeric binder, for example, but not limited to, extruded wood products, filled polymeric compositions, urethane foams, or any other suitable material. In one embodiment, the polymeric binder of the base layer is an acrylated, epoxidized, or esterified biobased polymer such that the polymer components are derived from natural, renewable sources as opposed to petroleum products. Additionally or alternatively, filled polymeric compositions have fillers obtained from natural, renewable sources, such as, aragonite. Additionally, the base layer could be a rubber-based, elastomeric-based material or a wood plastic composite type of material which is a combination of cellulosic with polymeric or filled polymeric or elastomeric material.

Densified wood is prepared by several methods, for example, by injecting a resin such as phenol, into the wood to strengthen the wood by the curing of the resin. Wood may also be densified by a combination of injecting resins and compressing the wood. Other methods include a process whereby the wood is subjected to an elevated temperature and moisture, compressing the wood component perpendicular to the grain, and annealing the wood to ambient conditions.

In one embodiment, the densification of wood increased the density to about 1.30 times or greater of the initial density of the wood. In another embodiment, the densified wood product having a densified veneer is obtained from species of hard wood, soft wood, or tropical wood.

The manufacture of wood flooring products is known in the arts. In one embodiment, a densified wood product having a densified veneer is fashioned into planks, having an edge perpendicular to the face and any combination of thickness, width, and length as required. In another embodiment, the densified wood product having a densified veneer is fashioned into planks, having any combination of thickness, width, and length as required and the elongated edges machined to include a tongue and groove feature. In yet another embodiment, the densified wood product having a densified veneer is fashioned into planks, having any combination of thickness, width and length as required and the elongated edges further machined to have locking tongue and groove features.

In one embodiment, a wood flooring product having dimensions of thickness, width and length vary to suit the application. Thickness varies from about 1/16 inch to about 1 inch, from about 1/16 inch to about ¼ inch, from about ¼ inch to about ⅜ inch, from about 5/16 inch to about ½ inch, from about ⅝ inch to about 7/16 inch, from ¾ inch to about 1 inch, or any size in between. Flooring width varies from about 2 inches to about 24 inches, from about 2 inches to about 3¼ inches, from about 3¼ inches to about 5 inches, and from about 5 inches to about to 12 inches, from about 12 inches to about 16 inches, from about 12 inches to about 24 inches, or any size in between. Lengths are, for example, but not limited to, about one-half foot to about twelve feet, from about one-half foot to about one foot, from about three feet to about six feet, from about eight feet to about ten feet, from about ten feet to about twelve feet, from about one-half meter to about one meter, from about two meters to about three meters and from about three meters to about four meters, or any size in between. In one embodiment, the flooring is a square tile having equal dimensions of two adjacent sides from about 2 inches to about 24 inches, from about 2 inches to about 2 inches, from about 4 inches to about 4 inches, from about 6 inches to about 6 inches, from about 9 inches to about 9 inches, from about 12 inches to about 12 inches, from about 16 inches to about 16 inches, from about 18 inches to about 18 inches, from about 24 inches to about 24 inches, or any size in between.

Wood flooring products are subjected to impacts from objects that may be inadvertently dropped onto flooring surfaces. It is not possible to know all of the factors related to the dropped objects (shape, weight, height of drop) or the condition of the environment in which the floor is located (types of subfloor, degree of adhesion to subfloor, temperature). Wood floor specimens having a densified first layer are evaluated for impact resistance using a ball drop test method which provides a relative measure of resistance to impact of wood flooring. In one embodiment, the wood flooring product having densified first layer has an indent resistance greater than untreated wood.

Width and thickness dimensions of wood flooring typically change when wood flooring is exposed to variations in EMC. Wood flooring maintains dimensional stability in the ambient relative humidity range between about 30 percent to about 50 percent. Humid conditions occur when the ambient relative humidity is above 50 percent, above 60 percent, above 70 percent, and above 80 percent. Conversely, dry conditions occur when the ambient relative humidity is less than 30 percent, less than 20 percent, and less than 10 percent. In moist conditions, moisture adsorption causes wood flooring boards to expand across the width of the boards. Conversely, in dry conditions, moisture desorption causes wood flooring boards to contract across the width of the boards. In both moist and dry conditions, the cumulative effects of expansion and contraction result in cupping and crowning across wood flooring boards. The potential to cup or crown is a limitation for use of wood flooring in below grade or other installations which typically have wet or moist conditions as well as dry conditions and is further exacerbated when wider width wood flooring, for example, greater than 3.25 inches wide, is installed. In one embodiment, the densified wood product having a densified veneer has greater resistance to dimensional changes due to EMC changes than untreated wood. Additionally, the wood flooring product having a densified veneer is dimensionally stable as associated with wet and dry conditions and, therefore, is suitable for installations below grade or having moist conditions as well as dry conditions. In one embodiment, a wood flooring product having a densified veneer has a width greater than 3.25 inches.

Wood flooring products, especially solid wood and veneer, fade or change shades over time. Exposure to sunlight greatly exacerbates this problem. Methods in the art to slow the fading process include treatments, for example, a surface treatment containing ultraviolet inhibitors that add additional cost to the manufactured product and further hinder refinishing techniques. In one embodiment, wood flooring products having a densified first layer without additional treatments have favorable light stability as compared to untreated wood.

The invention will be further described with respect to the following examples; however, the scope of the invention is not limited thereby.

### EXAMPLES

### Example 1

Impact resistance is conducted where a 1½ inch diameter steel ball, supported in a housing, is dropped from a predetermined height and the impact depth, if any, in the surface of the flooring product is measured at its greatest depth. A smaller depth or penetration denotes a greater impact resistance. First layers comprising an exemplary hard wood (hard maple) and an exemplary soft wood (yellow pine) were evaluated to understand the influence of thermal compression on impact resistance. As shown in Table 1, the influence of thermal compression on a hard wood is minimal. In contrast, Table 2 illustrates that the influence of thermal compression on soft wood is significant. Specifically, the data described in Table 2 demonstrates that exemplary products of the present invention demonstrate an unexpected improvement in impact resistance.

TABLE 1

| Product | Indent (inches) |
|---|---|
| Comparative Example I | 0.014 |
| (Untreated Hard Maple) | |
| Comparative Example II | 0.013 |
| (Thermally Compressed Hard Maple) | |

TABLE 2

| Product | Indent (inches) |
|---|---|
| Comparative Example III | 0.034 |
| (Untreated Yellow Pine) | |
| Example I | 0.011 |
| (Thermally Compressed Yellow Pine) | |
| Example II | 0.011 |
| (Thermally Compressed Yellow Pine) | |

### Example 2

Thermally compressed and untreated samples are evaluated for color difference based on the calculation of delta values as the deviation of the measured x, y color coordinates from a black body radiator. Test duration affords exposure to 100 hours of xenon arc, having 280 nm-800 nm wavelength, and filtered to approximate sunlight through window glass. At the conclusion of the test, results are the differential from the initial color reading to the final color reading. Less of a difference is favorable, as shown in Table 3, a wood product having a thermally compressed first layer has a greater resistance to fading than untreated wood.

TABLE 3

| Product | ΔE after 100 hours |
|---|---|
| Comparative Example IV | 27.4 |
| (Untreated Yellow Pine) | |
| Example III | 10.8 |
| (Thermally Compressed Yellow Pine) | |
| Example IV | 5.8 |
| (Thermally Compressed Yellow Pine) | |
| Example V | 13.5 |
| (Thermally Compressed Yellow Pine) | |

### Example 3

Moisture resistance is evaluated where specimens of untreated and densified wood are conditioned to yield an equilibrium moisture content of approximately 4 percent. Initial specimen weights are recorded. Test specimens are subjected to 79 percent relative humidity, at 25° C., (approximately fifteen percent EMC) for nine days. At the conclusion of the test, specimens are weighed and the percent of moisture gain reported. As shown in Table 3, densified wood has a lower moisture uptake than untreated wood.

TABLE 3

| Product | Total Moisture Gain (% MC) |
|---|---|
| Comparative Example V | 9.7 |
| (Untreated Yellow Pine) | |
| Example VI | 6.6 |
| (Thermally Compressed Yellow Pine) | |
| Example VII | 7.5 |
| (Thermally Compressed Yellow Pine) | |
| Example VIII | 6.3 |
| (Thermally Compressed Yellow Pine) | |
| Example IX | 6.4 |
| (Thermally Compressed Yellow Pine) | |
| Example X | 8.1 |
| (Thermally Compressed Yellow Pine) | |
| Example XI | 5.7 |
| (Thermally Compressed Yellow Pine) | |

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A hybrid wood product, comprising:
a first layer comprising a first thermally compressed cellulosic substrate;
a second layer comprising a fiberboard, a wood-plastic composite, or a vinyl composite; and
a locking profile.

2. The hybrid wood product of claim 1, wherein the first thermally compressed cellulosic substrate comprises a cellulosic material derived from a soft wood or a tropical wood.

3. The hybrid wood product of claim 1, wherein the first thermally compressed cellulosic substrate comprises a cellulosic material derived from Caribbean walnut, coffee bean, natural bamboo, Australian cypress, white oak, Tasmanian oak, ribbon gum, ash, American beech, red oak, Caribbean heart pine, yellow birch, Movingui, heart pine, Carapa Guianensis, larch, carbonized bamboo, teak, cocobolo, rose gum, Makore, Siberian larch, Peruvian walnut, Boreal, black walnut, cherry, red maple, boire, paper birch, eastern red cedar, southern yellow pine, lacewood, African mahogany, Honduran mahogany, Parana, sycamore, Shedua, silver maple, Douglas fir, juniper, chestnut, hemlock, western white pine, basswood, eastern white pine, balsa, cuipo or a combination of two or more thereof.

4. (canceled)

5. The hybrid wood product of claim 1, wherein the second layer comprises a fiberboard.

6. The hybrid wood product of claim 5, wherein the fiberboard comprises a binder and a matrix of cellulosic fibers.

7. (canceled)

8. The hybrid wood product of claim 6, wherein the binder comprises a formaldehyde based resin, isocyanate, polyvinyl alcohol, soy, or a combination of two or more thereof.

9. (canceled)

10. The hybrid wood product of claim 5, wherein the fiberboard has a moisture content of less than 9%.

11. The hybrid wood product of claim 5, wherein the fiberboard has a density of from about 10 lbs./ft³ to about 75 lbs./ft³.

12. The hybrid wood product of claim 5, wherein the fiberboard has a thickness of from about 3 mm to about 14 mm.

13. The hybrid wood product of claim 1, wherein the second layer has a modulus of elasticity of from about 30,000 psi to about 1,000,000 psi.

14. The hybrid wood product of claim 1, wherein the second layer is bonded to the first layer using an adhesive.

15. The hybrid wood product of claim 1, wherein the locking profile is selected from tongue and groove; lock and fold; ship-lap; angle-angle; and click-lock.

16. (canceled)

17. The hybrid wood product of claim 1, wherein the second layer comprises the locking profile.

18. The hybrid wood product of claim 17, wherein the adhesive comprises a pressure sensitive adhesive.

19. The hybrid wood product of claim 1, having a thickness of from about 6 mm to about 12 mm.

20. The hybrid wood product of claim 1, having a width of from about 75 mm to about 200 mm.

21. The hybrid wood product of claim 1, further comprising a third layer comprises a second thermally compressed cellulosic substrate.

22. (canceled)

23. The hybrid wood product of claim 21, wherein the second thermally compressed cellulosic substrate comprises a cellulosic material derived from a soft wood or a tropical wood.

24. The hybrid wood product of claim 23, wherein the second thermally compressed cellulosic substrate comprises a cellulosic material derived from Caribbean walnut, coffee bean, natural bamboo, Australian cypress, white oak, Tasmanian oak, ribbon gum, ash, American beech, red oak, Caribbean heart pine, yellow birch, Movingui, heart pine, Carapa Guianensis, larch, carbonized bamboo, teak, cocobolo, rose gum, Makore, Siberian larch, Peruvian walnut, Boreal, black walnut, cherry, red maple, boire, paper birch, Eastern red cedar, southern yellow pine, lacewood, African mahogany, Honduran mahogany, Parana, sycamore, Shedua, silver maple, Douglas fir, juniper, chestnut, hemlock, western white pine, basswood, eastern white pine, balsa, cuipo and a combination of two or more thereof.

25. The hybrid wood product of claim 20, wherein the first thermally compressed cellulosic substrate and the second thermally compressed cellulosic substrate are comprised of the same material.
